(19) United States
(12) Patent Application Publication
(10) Pub. No.: US 2026/0204735 A1
(43) Pub. Date: Jul. 16, 2026

(54) LEAD ASSEMBLY FOR BATTERY CELL MONITORING

(71) Applicant: CPS Technology Holdings LLC, New York, NY (US)

(72) Inventors: Rengaraj BALAKRISHNAN, Raleigh, NC (US); Jason D. FUHR, Sussex, WI (US); Arunraj VARATHARAJAH, Menomonee Falls, WI (US); Tyler Anthony THIEL, Glendale, WI (US); Jeffrey L. TROXEL, Menomonee Falls, WI (US); Ronald J. DULLE, Mequon, WI (US)

(21) Appl. No.: 19/133,091

(22) PCT Filed: Dec. 22, 2023
(86) PCT No.: PCT/US2023/085813

§ 371 Date: May 27, 2025

Related U.S. Application Data
(60) Provisional application No. 63/477,467, filed on Dec. 28, 2022.

(51) Int. Cl. H01M 50/503; H01M 10/42; H01M 50/209; H01M 50/271; H01M 50/296; H01M 50/516; H01M 50/517

(52) U.S. Cl. CPC H01M 50/503; H01M 10/425; H01M 50/209; H01M 50/271; H01M 50/296; H01M 50/516; H01M 50/517; H01M 2010/4271

(57) ABSTRACT

A lead assembly of a battery is described. The battery includes a plurality of posts associated with a plurality of battery cells. The lead assembly includes a plurality of leads, and each lead is electrically couplable to one post of the plurality of posts. The lead assembly also includes a lead assembly layer physically couplable to the battery. The lead assembly layer has a first surface and a second surface opposite the first surface. At least a portion of each lead of the plurality of leads is positioned between the first surface and the second surface of the lead assembly layer or on the first surface of the lead assembly layer.

### TECHNICAL FIELD

This disclosure relates to batteries and in particular to features within a smart battery to facilitate battery performance/failure monitoring.

### BACKGROUND

As battery technology evolves, the demand for improved power sources such as energy storage modules for vehicles continues to grow. Existing battery systems, for example lead acid battery systems, typically offer limited access to performance and failure monitoring, and have complex venting arrangements. More specifically, existing lead acid battery systems may not be capable of providing one or more battery parameters (e.g., usable to determine performance and/or predict/monitor failure) of one or more battery cells of the lead acid battery system. In other words, it is difficult for existing lead acid battery systems to provide information about vital components, such as the state of health of the battery cells. Accordingly, the state of health of battery cells cannot easily be monitored and/or determined, thus hindering the ability to predict upcoming battery failure or the onset of failure.

### SUMMARY

Some embodiments advantageously provide a method and apparatus, e.g., smart battery and/or lead assembly.

According to one aspect, a lead assembly of a battery comprising a plurality of battery cells is described. The lead assembly comprises a plurality of leads, where each lead is arranged to be connected to a battery cell of the plurality of battery cells. The lead assembly further comprises a lead assembly layer couplable to the battery and one of comprising the plurality of leads and being arranged to receive the plurality of layers on top of the lead assembly layer.

According to another aspect, a battery is described. The battery comprises a plurality of battery cells, a plurality of posts, and a lead assembly. Each post of the plurality of posts is electrically coupled to at least one battery cell of the plurality of cells. The lead assembly comprises a plurality of leads and a lead assembly layer. Each lead is coupled to one post of the plurality of post. The lead assembly layer is coupled to the battery and comprises the plurality of leads or is arranged to receive the plurality of layers on top of the lead assembly layer.

According to one aspect, a method of assembling a lead assembly of a battery is described. The method comprises arranging a plurality of leads separate from each other and molding a lead assembly layer over the plurality of leads or receiving the plurality of leads on top of the lead assembly layer.

According to another aspect, a lead assembly of a battery is described. The battery includes a plurality of posts associated with a plurality of battery cells. The lead assembly includes a plurality of leads, and each lead is electrically couplable to one post of the plurality of posts. The lead assembly also includes a lead assembly layer physically couplable to the battery. The lead assembly layer has a first surface and a second surface opposite the first surface. At least a portion of each lead of the plurality of leads is positioned between the first surface and the second surface of the lead assembly layer or on the first surface of the lead assembly layer.

In some embodiments, each lead of the plurality of leads comprises a first end and a second end opposite the first end, the first end being couplable to the one post, the second end being couplable to a battery management system.

In some other embodiments, the first end comprises one or both of a ring and one or more post connectors coupled to the ring, the ring and the one or more post connectors being couplable to the one post.

In some embodiments, when the at least portion of each lead of the plurality of leads is positioned between the first surface and the second surface, the second end of each lead is not positioned between the first surface and the second surface and extends away from the first surface.

In some other embodiments, the lead assembly further includes a first connector coupled to the second end of each lead of the plurality of leads, and the first connector is couplable to the battery management system.

In some embodiments, the lead assembly further includes an arm arranged to adjust a location of the first end of one lead of the plurality of leads and couple the first end of the one lead to one post that is associated with a battery terminal.

In some other embodiments, the plurality of leads includes at least a first lead, a second lead, and a common lead portion electrically coupling the first lead to the second lead. The lead assembly layer includes an opening arranged to provide access to the common lead portion to electrically decouple the first lead from the second lead.

In some embodiments, one or more leads of the plurality of leads include a strain relief portion.

In some other embodiments, when the at least portion of each lead of the plurality of leads is positioned on the first surface of the lead assembly layer, the first surface includes one or more clamps, and each clamp is arranged to secure a corresponding lead to the first surface.

In some embodiments, the lead assembly further includes at least a receiver. The receiver has an opening arranged to receive an end of one lead of the plurality of leads and at least a portion of the one post to couple the lead to the post.

In some other embodiments, one or more leads of the plurality of leads are a stamped lead or a wire.

In some embodiments, when the at least portion of each lead of the plurality of leads is positioned between the first surface and the second surface, the lead assembly layer is molded over the plurality of leads.

According to another aspect, a battery includes a plurality of battery cells and a plurality of posts. Each post of the plurality of posts is electrically coupled to one or more battery cells of the plurality of battery cells. The battery also includes a case, a cover, and a lead assembly. The case houses the plurality of battery cells and at least a first portion of each post of the plurality of posts. The cover is coupled to the housing and having a plurality of openings, and at least a second portion of each post protrudes through a corresponding opening and extends away from the cover. The lead assembly includes a plurality of leads and a lead assembly layer. Each lead is electrically couplable to the second portion of one post of the plurality of posts. The lead assembly layer is physically couplable to the cover of the battery. The lead assembly layer has a first surface and a second surface opposite the first surface. At least a portion of each lead of the plurality of leads is positioned between the first surface and the second surface of the lead assembly layer or on the first surface of the lead assembly layer.

In some embodiments, the battery further includes a battery management system. Each lead of the plurality of leads comprises a first end and a second end opposite the first end. The first end is couplable to the second portion of the one post, and the second end is couplable to the battery management system.

In some other embodiments, the battery further includes a plurality of bushings, where each bushing is coupled to a corresponding post.

In some embodiments, each bushing is coupled to the corresponding post by forming a first weld between the busing and the corresponding post.

In some other embodiments, each lead of the plurality of leads is welded to the corresponding first weld.

According to another aspect, a method for assembling a lead assembly of a battery is described. The lead assembly includes a plurality of leads and a lead assembly layer. The lead assembly layer has a first surface and a second surface opposite the first surface. The battery includes a battery management system and plurality of posts associated with a plurality of battery cells. The method includes arranging a plurality of leads separate from each other and molding the lead assembly layer over the plurality of leads or securing the plurality of leads onto the first surface. The molded lead assembly layer includes the plurality of leads between the first surface and the second surface. The method also includes coupling each lead of the plurality of leads to one post of the plurality of posts and the battery management system.

In some embodiments, each lead of the plurality of leads comprises a first end and a second end opposite the first end, and the method further includes coupling the first end to the one post and coupling the second end to the battery management system.

In some other embodiments, the method further includes coupling the one post to a bushing and coupling the coupled one post and bushing to the first end of the corresponding lead.

In some embodiments, the lead assembly further includes a first connector, and the method further includes coupling the first connector to the second end of each lead of the plurality of leads and coupling the first connector to the battery management system.

In some other embodiments, the lead assembly further includes an arm, and the method further includes adjusting, using the arm, a location of the first end of one lead of the plurality of leads and coupling the first end of the one lead to one post that is associated with a battery terminal.

In some embodiments, the first surface includes one or more clamps, The method further includes securing the plurality of leads onto the first surface using each clamp of the one or more clamps.

In some other embodiments, the lead assembly further includes at least a receiver, the receiver has an opening, and the method further includes receiving, in the opening, an end of one lead of the plurality of leads and at least a portion of the one post to couple the end of the one lead to the post.

In some embodiments, the method further includes performing a stamping of one or more leads of the plurality of leads.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows an example battery and one or more components of the example battery according to the principles of the present disclosure;

FIG. 2 shows an example battery (e.g., exploded view) and one or more components of the example battery according to the principles of the present disclosure;

FIG. 3 shows an example post assembly already coupled to a plurality of battery cells according to the principles of the present disclosure;

FIG. 4 shows an example first cover viewed from three different angles according to the principles of the present disclosure;

FIG. 5 shows an example of a plurality of leads according to the principles of the present disclosure;

FIG. 6 shows an example of a lead assembly according to the principles of the present disclosure;

FIG. 7 shows a welding process according to the principles of the present disclosure;

FIG. 8 shows a welding process according to the principles of the present disclosure;

FIG. 9 shows another example of a plurality of leads according to the principles of the present disclosure;

FIG. 10 shows another example of a lead assembly according to the principles of the present disclosure;

FIG. 11 shows another example assembly step according to the principles of the present disclosure;

FIG. 12 shows yet another example of a lead assembly according to the principles of the present disclosure;

FIG. 13 shows an example a post, a bushing, and ring being coupled according to the principles of the present disclosure;

FIG. 14 shows another example a post, a bushing, and ring being coupled according to the principles of the present disclosure;

FIG. 15 shows the lead assembly of FIG. 12 coupled on a first cover according to the principles of the present disclosure;

FIG. 16 shows an example assembly method of a lead assembly for a battery according to the principles of the present disclosure;

FIG. 17 shows an example assembly method of a lead assembly for a battery according to the principles of the present disclosure; and

FIG. 18 shows an example BMS according to the principles of the present disclosure.

### DESCRIPTION

The embodiments of the present disclosure provide improved power sources, and more efficient and effective methods for manufacturing such power sources as compared to conventional systems and methods.

Accordingly, embodiments described and shown herein provide a battery and method of assembly of the battery that allows smart features to be integrated within a battery that, in some embodiments, can take the same general shape and form as batteries that do not offer “smart battery” features, such as (as a non-limiting example) the ability to monitor individual cell voltages. In some embodiments, at least one lead connected to a corresponding battery cell may be connected to a battery management system (BMS), e.g., to determine/measure at least one parameter, such as cell voltage, cell current, cell temperature, etc. In some other embodiments, one or more leads are comprised in a lead assembly, where the lead assembly is mounted on a cover of a battery and connected to at least one battery cell and a BMS.

In some embodiments, the term “smart battery” may be used and may refer to a battery having, for example, lead, lithium or sodium chemistries, that are enabled by electronics physically attached to the battery for monitoring battery functional parameters, such as but not limited to state of charge, state of health and/or trends thereof, or communicating battery conditions internally within or externally from the battery environment. The electronics may be generally referred to as connected electronics and may include a battery management system or any other electronic component. Further, electronics may utilize wired or wireless transmission devices or communication interfaces configured for communication of data and/or information, such as applicable battery information and/or derivatives of the battery information.

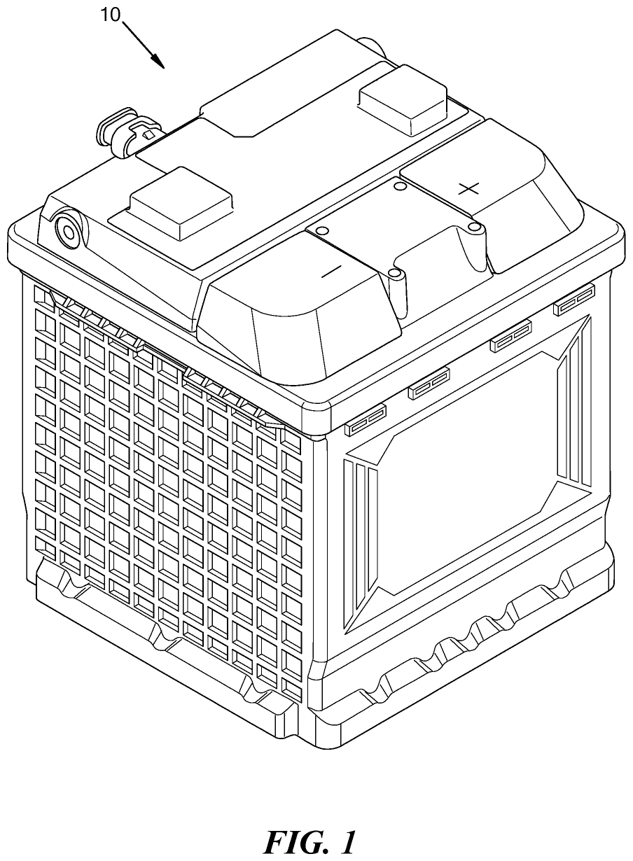

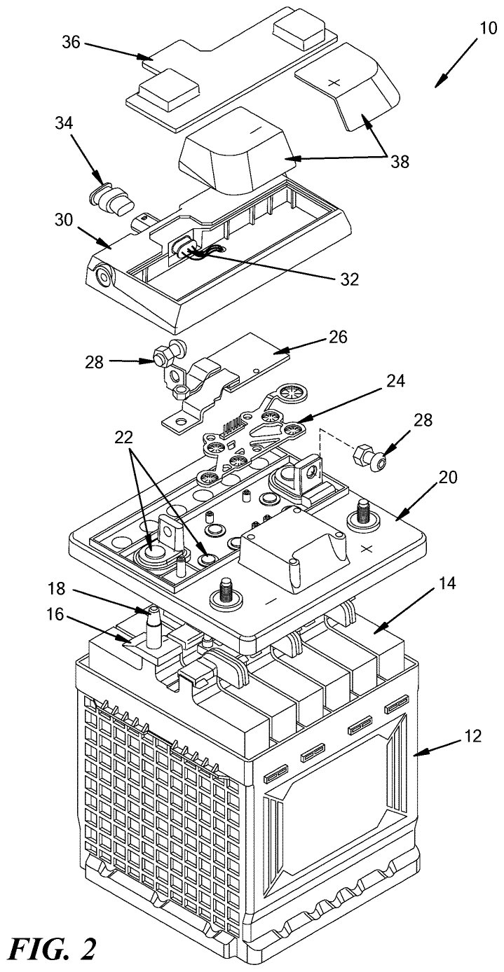

FIGS. 1 and 2 show an example battery (e.g., a lead acid battery having a smart Absorbent Glass Mat (AGM) battery assembly) and one or more components of the example battery. Battery 10 may include at least one of the following: a case 12 (which may be made of from a resin or any other suitable material), one or more battery cells 14, a post assembly 16 (e.g., Cast-On-Strap (COS) post assembly), one or more posts 18 (e.g., a terminal post, a mini-post), a first cover 20, one or more bushings 22 (e.g., a U1 bushing, a mini-bushing), a lead assembly 24 (e.g., a lead frame), a battery management system 26 (e.g., including a board), one or more fasteners 28, a second cover 30, a wiring harness 32, a vehicle connector 34, a third cover 36, and one or more terminal caps 38.

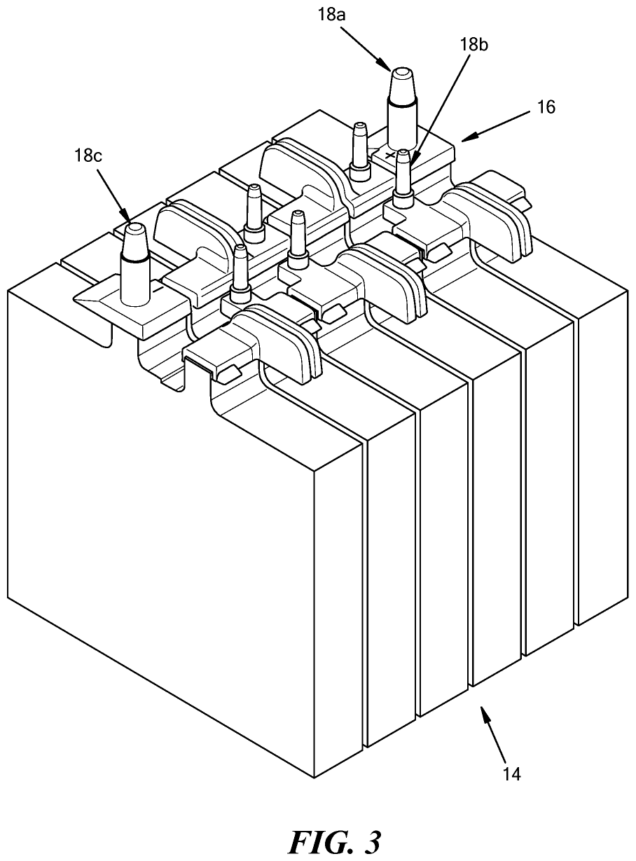

FIG. 3 shows an example post assembly 16 already coupled to the plurality of battery cells. In some embodiments, post assembly 16 and/or the coupling of post assembly 16 (and/or its components) to battery cells 14 is made/performed using a COS process. In a nonlimiting example, assembly (and/or coupling) of the posts 18 (e.g., posts/COS) to the battery cells 14 may be performed by using liquid lead poured into a mold over the battery cells 14 and/or left to harden. In some other embodiments, a post 18 (e.g., a first post 18a) is electrically connected to a positive electrode of one or more battery cells 14 and/or electrically connectable to a positive terminal of battery 10. In one embodiment, at least another post 18 (e.g., a second post 18b a mini post) is electrically connected to one or more battery cells 14. In some embodiments, a post 18 (e.g., a third post 18c) is electrically connected to a negative electrode of one or more battery cells 14 and/or electrically connectable to a negative terminal of battery 10. In a nonlimiting example, each one of five posts 18 (e.g., mini posts) are electrically connected to one battery cell 14 and/or one post 18 (e.g., terminal post) is electrically connected to a positive electrode and/or another post 18 (e.g., terminal post) is electrically connected to a negative electrode. In some other embodiments, each post may be physically over a cell and/or electrically connected to the cell and/or another cell. In a nonlimiting example, a post 18 (e.g., mini-post) located (i.e., installed) directly over a battery cell 14 may be electrically connected to the battery cell 14. In another nonlimiting example, a post 18 (e.g., mini-post) located (i.e., installed) directly over a battery cell 14 may be electrically connected to another battery cell 14.

FIG. 4 shows an example first cover 20. First cover 20 may comprise bushings 22, terminals 40, terminal posts 42, openings 44, and openings 46. Each opening 46 may be arranged to receive a bushing 22 and/or a post 18. Terminals 40 may be a positive terminal or a negative terminal, each electrically connected to a corresponding terminal post 42. Further, openings 44 may be vent openings arranged to be in fluid communication with the case internal space.

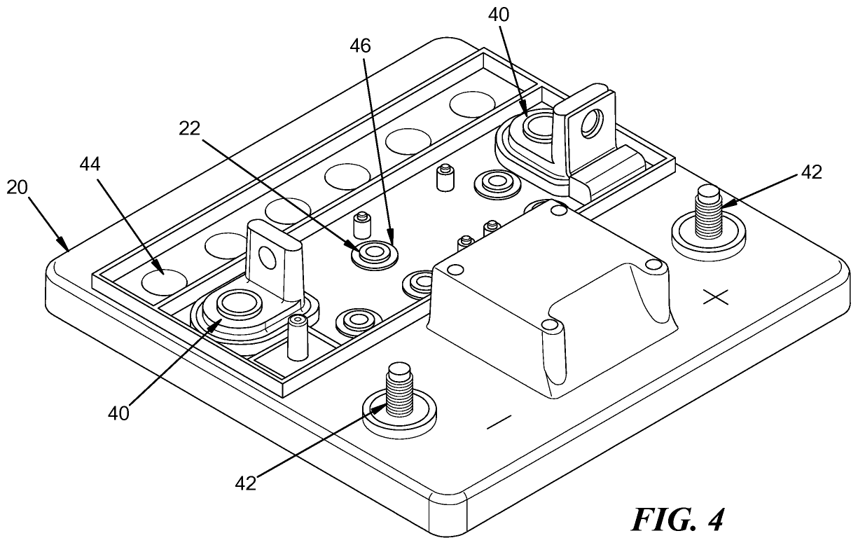

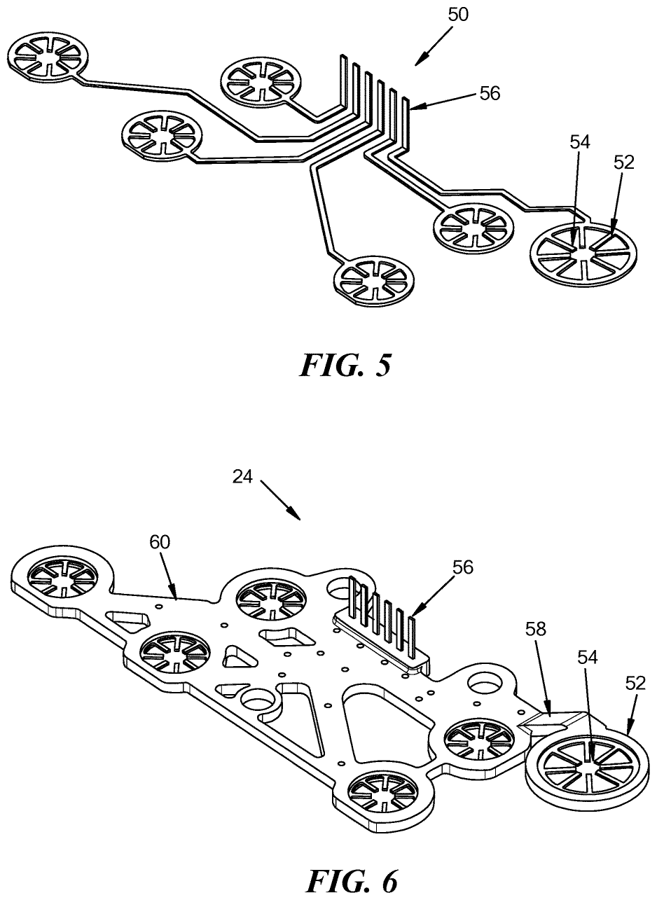

FIG. 5 shows an example of a plurality of leads 50 (e.g., six leads) and a lead assembly (e.g., including the plurality of leads 50). Each lead 50 may include one or more of each of the following: a lead ring 52, a post connector 54 (e.g., a spoke), and a lead BMS connector 56 (e.g., pin, space, etc.). Ring 52 and/or post connector 54 may be referred to as a first end and arranged to physically and/or electrically connect lead 50 to a post 18. BMS connector 56 may be referred to as a second end and be arranged to extend from the ring and/or bend to a predetermined angle and/or physically and/or electrically connect to BMS 26 (and/or any of its components). Lead 50 may be made of any material including conductive materials, e.g., to conduct electricity and/or propagate signals. In a nonlimiting example, lead 50 may refer to a stamped frame and/or be made of at least one of copper, brass, steel, aluminum, titanium, platinum, etc. Further, lead 50 may include a coating and/or a finish such as a finish using copper, nickel, tin, palladium, silver, gold, zinc, etc. Lead 50 may be used by BMS 26 to measure/determine one or more parameters associated with a post 18 and/or corresponding battery cell 14. Parameters may include, without limitation, voltage, current, temperature, pressure, etc., and may be associated with any component of battery 10, e.g., post 18, battery cell 14, etc. Lead(s) 56 (e.g., stamped leads) may be comprised in a lead assembly 24, e.g., an over molded assembly).

FIG. 6 shows an example of a lead assembly 24 according to the principles of the present disclosure. More specifically, any portion of each lead 50 may be hinged and/or adapted to be flexible and/or adjustable, e.g., to connect lead 50 to a post 18 that may be in a different plane than a plane corresponding to another portion of lead assembly 24. A terminal 40 and/or corresponding post 18 may be located on a different plane than a plane where other posts 18 (e.g., mini-posts) are located. In other words, it is contemplated that terminals 40 and posts 18 need not be co-planar with respect to the top surface of the battery case 12. In a nonlimiting example, lead assembly 24 includes arm 58 which may be arranged to adjust the location of a portion of lead assembly 24, e.g., corresponding to a predetermined post 18 such as a portion that includes a ring 52 and/or post connector 54 for a positive terminal post that is not coplanar with others of the rings 52 in the lead assembly 24. In some embodiments, arm 58 can be pivotable to allow for adjustment. By having arm 58 adjustable, lead assembly 24 may be arranged to fit one or more posts/terminals having different locations. Further, ring 52 and post connector 54 may be sized based on a post type and/or any other parameter. In a nonlimiting example, ring 52 and/or post connector 54 may be made thicker and/or have a greater diameter than other rings 52 and/or post connectors 54 of lead assembly 24, e.g., to fit a size and type of a post of a positive terminal having a greater size and current rating. In a nonlimiting example, ring 52 and/or post connector 54 may be made thinner and/or have a smaller diameter than other rings 52 and/or post connectors 54 of lead assembly 24, e.g., to fit a size and type of a mini-post used to receive/transmit/measure a battery parameter. Lead assembly 24 may comprise a plurality of leads 50 and lead assembly layer 60. In some embodiments, lead assembly layer 60 may be an over molded layer or material or a base separate from the leads. In some other embodiments, lead assembly layer 60 may be a coating. For example, lead assembly 24 can be made by overmolding a polymer over the leads 50 to thereby provide structure for the leads 50. Lead assembly 24 can be rigid or flexible or a combination thereof depending on the intended design.

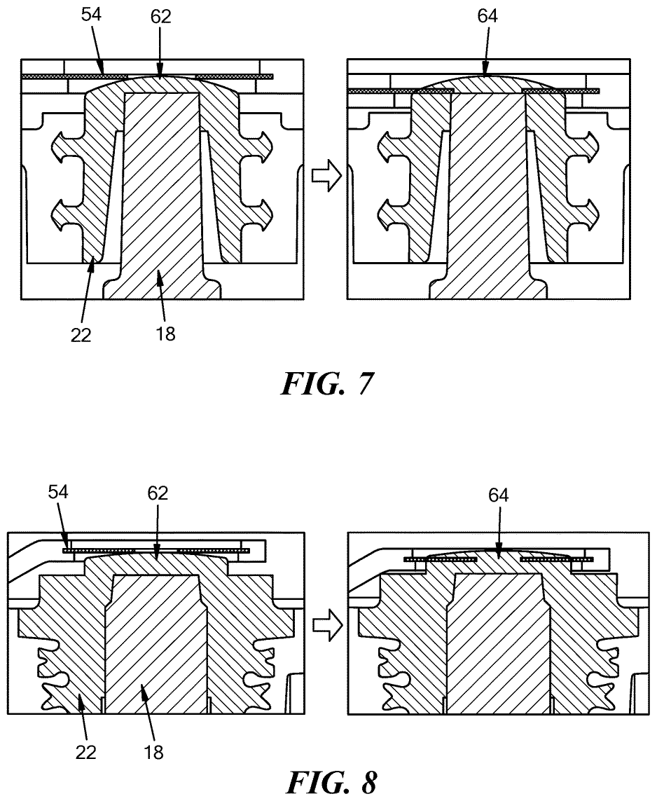

FIG. 7 shows a welding process associated with a post 18, which may be coupled to a battery cell 14. More specifically, post 18 and bushing 22 are welded, forming weld 62 (e.g., a burn, or button). Post connector 54 is placed (e.g., floated) over weld 62 and welded to weld 62, thereby forming weld 64. FIG. 8 shows a welding process associated with another post 18, which may be coupled to a battery terminal 40. More specifically, post 18 and bushing 22 are welded, forming weld 62 (e.g., a burn, or button). Post connector 54 is placed (e.g., floated) over weld 62 and welded to weld 62, thereby forming weld 64.

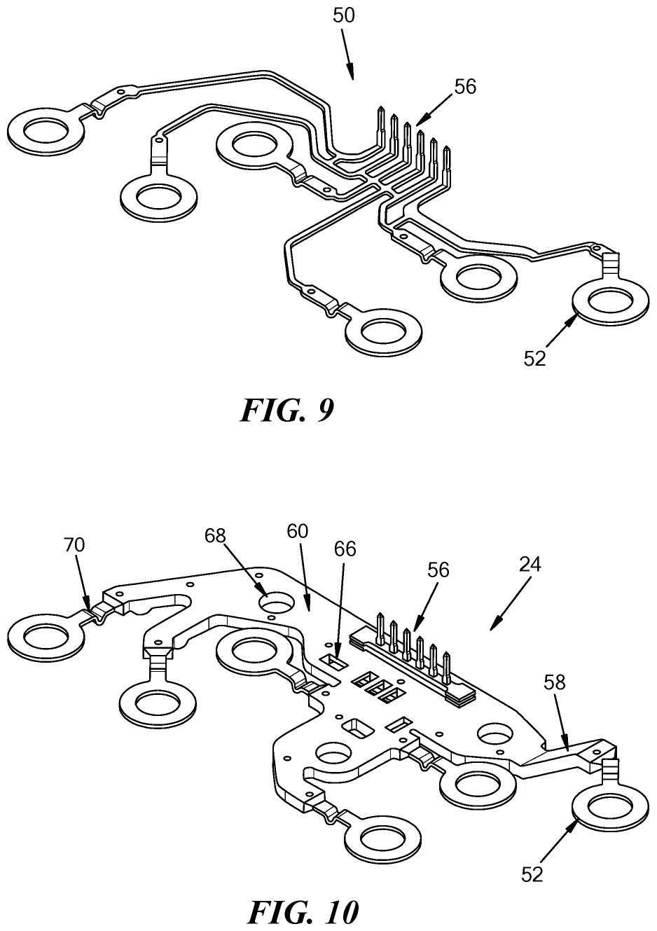

FIG. 9 shows another example of a plurality of leads 50 according to the principles of the present disclosure. Leads 50 may include BMS connector 56 (e.g., a second end) and a ring 52 (e.g., a first end). Although ring 52 is shown without post connector 54, ring 52 is not limited as such and may include any connector or be arranged to be a connector arranged to connect to post 18 (and/or bushing 22). Leads 50 may be stamped leads or any other type of leads such as formed leads. In some embodiments, at least one lead 50 (e.g., stamped leads) may be structurally connected to another lead 50 using a common lead portion. In some embodiments, the structural connection may also be an electrical connection between leads 50. In some other embodiments, the structural connection is not an electrical connection (e.g., a dielectric).

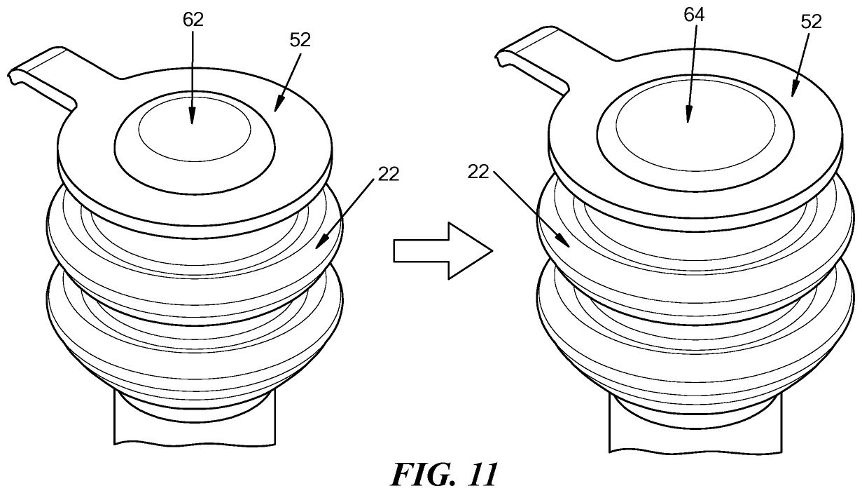

FIG. 10 shows another example of a lead assembly 24 according to the principles of the present disclosure. Lead assembly 24 comprises lead assembly layer 60 (e.g., overmolded plastic on top of leads 50, lead assembly base, etc.) and may be constructed to include opening 66 and opening 68. In some embodiments, opening 66 may be arranged to receive a portion of a battery component such as first cover 20 and/or to couple to the portion of the battery component. In some other embodiments, at least two leads 50 are coupled (as shown in FIG. 9) via a common lead portion. Opening 66 may be arranged to provide access to the common lead portion to electrically decouple one lead 50 from another lead 50. Opening 68 may also be receive a portion of a battery component such as first cover 20 and/or to couple to the portion of the battery component. In some embodiments, more than one of each one of opening 66 and opening 68 may be provided as part of lead assembly 24. Further, lead assembly 24 may comprise BMS connector 56 and ring 52 of leads 50. Any lead 50 may have a strain relief portion 70 which may facilitate rings 52 to provide strain relief functions (e.g., for stack-up tolerances) and/or to connect to post 18 and/or bushing 22. In addition, lead assembly 24 may include arm 58.

FIG. 11 shows another example bushing and leads before and after an assembly step according to the principles of the present disclosure. More specifically, ring 52 of lead 50 may be placed over weld 62 comprising bushing 22 (and/or post 18) (i.e., as a connector placement step). Welding may be performed such that a fixed connection such as weld 64 (e.g., electrical and/or physical connection) is established between ring 52 and bushing 22 (and/or post 18).

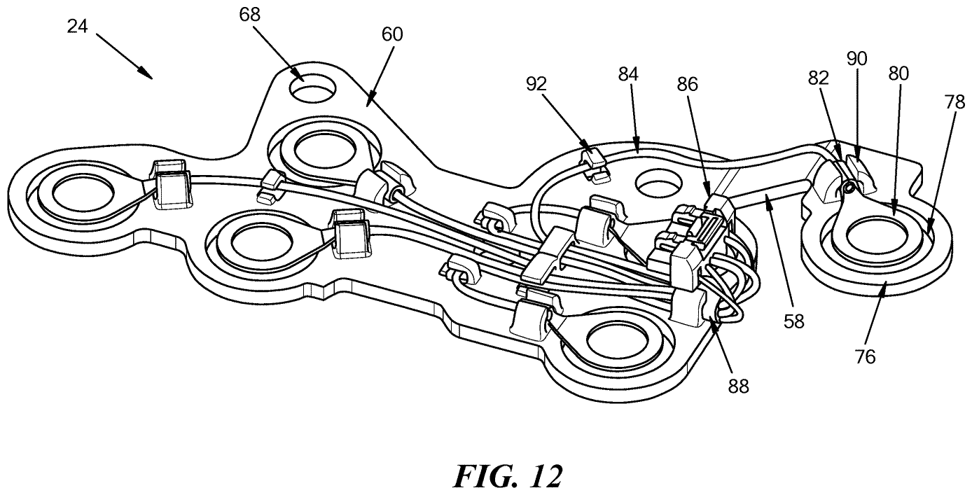

FIG. 12 shows yet another example of a lead assembly according to the principles of the present disclosure. Lead assembly 24 may include lead assembly layer 60 (e.g., a base) and/or one more openings 68. Lead assembly layer 60 may be arranged to be placed and/or coupled to a battery component such as first cover 20. Further, lead assembly layer 60 may comprise one or more receivers 76 arranged to receive at least ring 80 of lead 50 and/or bushing 22 (not shown) and/or post 18 (not shown), via opening 78. Ring 80 may be coupled (via coupling 82) to wire 84 on one end of wire 84, which may comprise an insulating coating. Coupling 82 may be arranged to couple ring 80 to wire 84 (e.g., using a crimping tool). The other end of wire 84 may be connected to and/or clamped by and/or received by connector 86 (which may be arranged to be connected to BMS 26). In some embodiments, wire 84 is similar to and/or comprises and/or refers to lead 50. Further, wires 84 may be grouped, secured, and/or bundled using strap 88, which may be coupled to lead assembly layer 60 and/or arranged to provide strain relief to wires 84. Strap 88 is not limited to being a strap and may be any other strain relief mechanism. In addition, clamp 90 may be arranged to guide and/or couple to and/or secure wires 84 (and/or ring 80 and/or coupling 82), and clamp 92 may also be arranged to guide and/or couple to and/or secure wires 84. In some embodiments, lead assembly layer 60 may refer to lead assembly layer 60. In some other embodiments, the arrangement shown in FIG. 12 is referred to as a wiring harness.

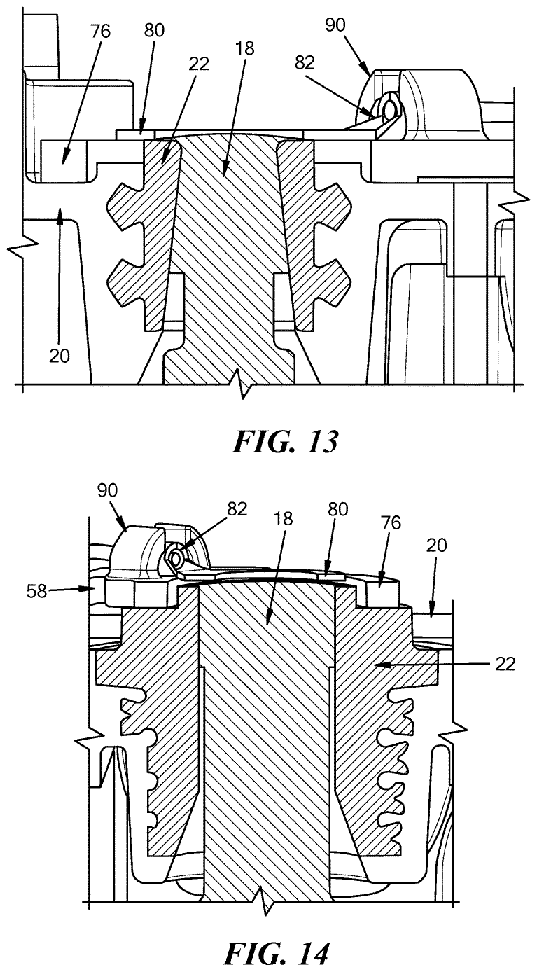

FIG. 13 shows an example a post 18, a bushing 22, and ring 80 being coupled (e.g., welded). More specifically, bushings 22 may be associated with a battery cell 14. Receiver 76 is placed on a battery component such as first cover 20 (or bushing 22) and/or receives post 18 and/or bushing 22, e.g., where receiver 76 is placed around at least a portion of post 18 and/or bushing 22. Ring 80 is in contact with and/or coupled to (e.g., welded to) post 18 and/or bushing 22. Ring 80 is coupled to coupling 82 which is secured by clamp 90. That is, ring 80 of wire 84 is electrically connected to post 18 which is electrically connected to a battery cell 14. Wire 84 may then be connected to BMS 26 via connector 86 (or BMS connector 56), where BMS 26 is configured to determine at least one parameter of battery cell 14 such as voltage. FIG. 14 shows another example a post 18, a bushing 22, and ring 80 being coupled (e.g., welded), where the post 18 is associated with a battery terminal 40, and lead assembly 24 includes arm 58 to adjust the position of receiver 76 and ring 80.

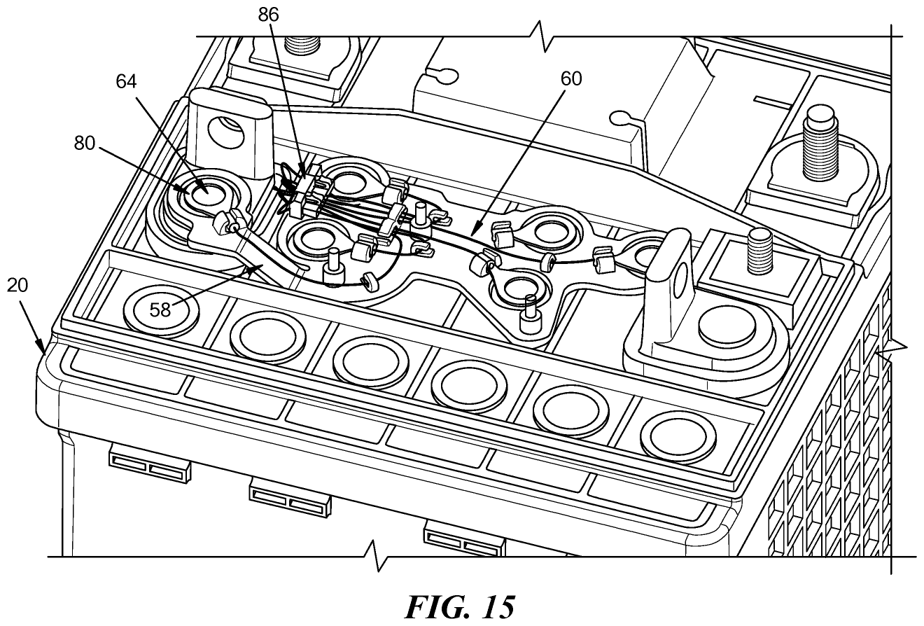

FIG. 15 shows the lead assembly of FIG. 12 mounted on a first cover 20 according to the principles of the present disclosure. First cover 20 may be arranged to receive lead assembly layer 60 of lead assembly 24, which may further include ring 80 (on one end of wire 84) coupled to post 18. The other end of wire 84 is coupled to and secured by connector 86. In some embodiments, the coupling of ring 80 to post 18 may be that of (or similar to) the coupling of ring 80 to post 18 (and bushing 22) of FIG. 13.

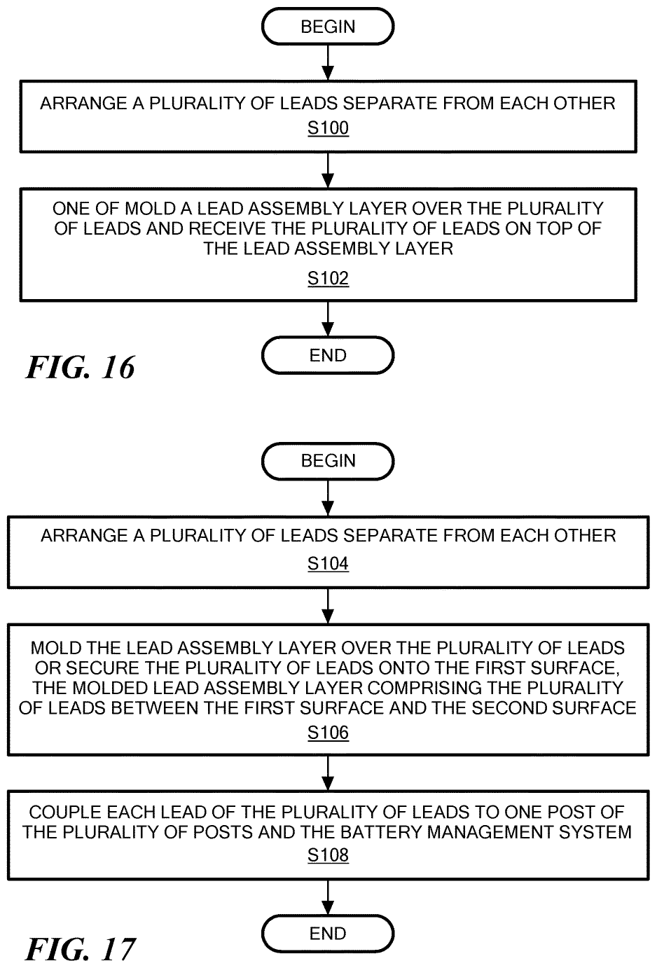

FIG. 16 shows an example assembly method of a battery 10. Battery 10 comprising a case 12, a plurality of battery cells 14, a first post 18a and a second post 18b, a first cover 20, a positive terminal 40, a lead assembly 24 including a first lead 50a and a second lead 50b, and a battery management system (BMS) 26. The method includes arrange (Block S100) a plurality of leads 50 separate from each other; and one of mold a lead assembly base over the plurality of leads 50 and receive (Block S102) the plurality of leads 50 on top of the lead assembly base.

FIG. 17 shows another example assembly method of a battery 10. The method includes arranging (Block S104) a plurality of leads 50 separate from each other and molding (Block S106) the lead assembly layer 60 over the plurality of leads 50 or securing the plurality of leads 50 onto the first surface. The molded lead assembly layer 60 includes the plurality of leads 50 between the first surface and the second surface. The method also includes coupling (Block S108) each lead 50 of the plurality of leads 50 to one post 18 of the plurality of posts 18 and the battery management system 26.

In some embodiments, each lead 50 of the plurality of leads 50 comprises a first end and a second end opposite the first end, and the method further includes coupling the first end to the one post and coupling the second end to the battery management system 26.

In some other embodiments, the method further includes coupling the one post 18 to a bushing 22 and coupling the coupled one post 18 and bushing 22 to the first end of the corresponding lead 50.

In some embodiments, the lead assembly 24 further includes a first connector 86, and the method further includes coupling the first connector 86 to the second end of each lead 50 of the plurality of leads 50 and coupling the first connector 86 to the battery management system 26.

In some other embodiments, the lead assembly 24 further includes an arm 58, and the method further includes adjusting, using the arm 58, a location of the first end of one lead 50 of the plurality of leads 50 and coupling the first end of the one lead 50 to one post 18 that is associated with a battery terminal 40.

In some embodiments, the first surface includes one or more clamps 90, 92. The method further includes securing the plurality of leads 50 onto the first surface using each clamp 90, 92 of the one or more clamps 90, 92.

In some other embodiments, the lead assembly 24 further includes at least a receiver 76, the receiver 76 has an opening 78, and the method further includes receiving, in the opening 78, an end of one lead 50 of the plurality of leads 50 and at least a portion of the one post 18 to couple the end of the one lead 50 to the post 18.

In some embodiments, the method further includes performing a stamping of one or more leads 50 of the plurality of leads 50.

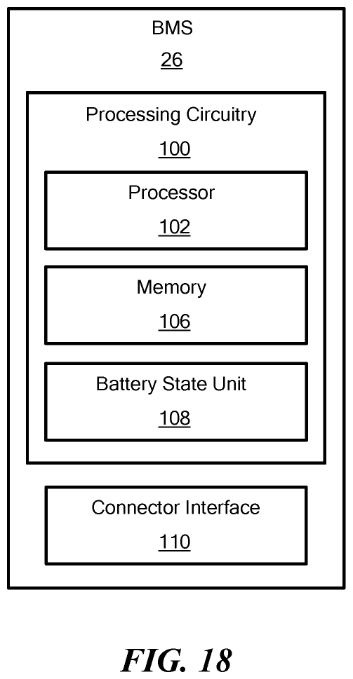

FIG. 18 shows an example BMS 26. BMS 26 may include at least one of processing circuitry 100, processor 102, memory 106, battery state unit 108, and connector interface 110. Processing circuitry 100, which may have storage and/or processing capabilities. The processing circuitry 100 may include processor 102 and memory 106. In particular, in addition to or instead of a processor, such as a central processing unit, and memory, the processing circuitry 100 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 102 may be configured to access (e.g., write to and/or read from) memory 106, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 100 may be configured to control any of the methods and/or processes described herein and/or to cause such methods, and/or processes to be performed, e.g., by BMS 26 and/or battery 10. Processor 102 corresponds to one or more processors 102 for performing battery 10 functions described herein. Memory 106 may be configured to store data, programmatic software code and/or other information described herein. In some embodiments, software may include instructions that, when executed by the processor 102 and/or processing circuitry 100, causes the processor 102 and/or processing circuitry 100 to perform the processes described herein. The instructions may be software associated with BMS 26 and/or battery 10. Further, battery state unit 108 may be configured to perform any of the steps and/or methods and/or functions and/or processes and/or features of the present disclosure, e.g., by BMS 26 and/or battery 10. Connector interface 110 may be any interface arranged/configured to connect to (and/or communicate with) any other device and/or component of battery 10 such as any lead 50 and/or wire 84 and/or BMS connector 56 and/or connector 86 and/or vehicle connector 34 and/or wiring harness 32 and/or any device by wireless/wired communication, e.g., using any communication protocol. Connector interface 110 may be in communication with any of the components of battery 10, such as processing circuitry 100, processor 102, memory 106, and/or battery state unit 108.

In a nonlimiting example, BMS 26 is configured to determine (i.e., capture, measure, read, etc.) data including battery cell data and/or battery cell parameters, e.g., via processing circuitry 100 and/or connector interface 110 and/or lead 50 of lead assembly 24 and/or wire 84 (and or ring 80) and/or post 18. More specifically, BMS 26 may be configured to determine a state of health of a battery cell 14 and/or battery 10 by using a connection that is established between BMS 26 and the battery cell 14 via leads 50, wire 84 (and/or ring 80) and post 18. Further, BMS 26 may be further configured to analyze the data. BMS 26 may also be configured to communicate the analyzed data or any other data, e.g., transmit/receive data which may include battery cell data and/or battery cell parameters, e.g., via wiring harness 32 and/or vehicle connector 34 and/or connector interface 110. The analyzed data or any other data may be transmitted to and/or received from another device, e.g., that may be connected to BMS 26 such as via vehicle connector 34 and/or connector interface 110. Communicating data may be performed using a protocol such as CAN and/or LIN via vehicle connector 34 to a vehicle and/or Bluetooth via connector interface 110 to a customer. That is, communicating data is not limited to wired connections/protocols and may also include the use of any wireless connections/protocols to communicate to one or more devices/systems. The arrangement described above is beneficial at least because battery 10 is capable of capture data such as battery cell data (e.g., lead acid battery cell data) and/or process the data and/or communicate the data for monitoring and/failure prediction of battery cells and other battery components.

It will be appreciated by persons skilled in the art that the present embodiments may be not limited to what may have been particularly shown and described. In addition, unless mention was made above to the contrary, it should be noted that all of the accompanying drawings may be not to scale. A variety of modifications and variations may be possible in light of the above teachings and following claims.

1. A lead assembly of a battery, the battery comprising a plurality of posts associated with a plurality of battery cells, the lead assembly comprising:
a plurality of leads, each lead being electrically couplable to one post of the plurality of posts; and
a lead assembly layer physically couplable to the battery, the lead assembly layer having a first surface and a second surface opposite the first surface, at least a portion of each lead of the plurality of leads being positioned:
between the first surface and the second surface of the lead assembly layer; or
on the first surface of the lead assembly layer.

2. The lead assembly of claim 1, wherein each lead of the plurality of leads comprises a first end and a second end opposite the first end, the first end being couplable to the one post, the second end being couplable to a battery management system.

3. The lead assembly of claim 2, wherein the first end comprises one or both of a ring and one or more post connectors coupled to the ring, the ring and the one or more post connectors being couplable to the one post.

4. The lead assembly of claim 2, wherein when the at least portion of each lead of the plurality of leads is positioned between the first surface and the second surface, the second end of each lead is not positioned between the first surface and the second surface and extends away from the first surface.

5. The lead assembly of claim 2, wherein the lead assembly further comprises a first connector coupled to the second end of each lead of the plurality of leads, the first connector being couplable to the battery management system.

6. The lead assembly of claim 2, wherein the lead assembly further includes an arm arranged to adjust a location of the first end of one lead of the plurality of leads and couple the first end of the one lead to one post that is associated with a battery terminal.

7. The lead assembly of claim 1, wherein the plurality of leads includes at least a first lead, a second lead, and a common lead portion electrically coupling the first lead to the second lead, the lead assembly layer includes an opening arranged to provide access to the common lead portion to electrically decouple the first lead from the second lead.

8. The lead assembly of claim 1, wherein one or more leads of the plurality of leads include a strain relief portion.

9. The lead assembly of claim 1, wherein when the at least portion of each lead of the plurality of leads is positioned on the first surface of the lead assembly layer, the first surface includes one or more clamps, each clamp being arranged to secure a corresponding lead to the first surface.

10. The lead assembly of claim 9, wherein the lead assembly further includes at least a receiver, the receiver having an opening arranged to receive an end of one lead of the plurality of leads and at least a portion of the one post to couple the lead to the post.

11. The lead assembly of claim 1, wherein one or more leads of the plurality of leads are a stamped lead or a wire.

12. The lead assembly of claim 1, wherein when the at least portion of each lead of the plurality of leads is positioned between the first surface and the second surface, the lead assembly layer is molded over the plurality of leads.

13. A battery comprising:
a plurality of battery cells;
a plurality of posts, each post of the plurality of posts electrically coupled to one or more battery cells of the plurality of battery cells;
a case housing the plurality of battery cells and at least a first portion of each post of the plurality of posts;
a cover being coupled to the case and having a plurality of openings, at least a second portion of each post protruding through a corresponding opening and extending away from the cover;
a lead assembly comprising:
a plurality of leads, each lead being electrically couplable to the second portion of one post of the plurality of posts; and
a lead assembly layer physically couplable to the cover of the battery, the lead assembly layer having a first surface and a second surface opposite the first surface, at least a portion of each lead of the plurality of leads being positioned:
between the first surface and the second surface of the lead assembly layer; or
on the first surface of the lead assembly layer.

14. The battery of claim 13, wherein the battery further includes a battery management system, each lead of the plurality of leads comprises a first end and a second end opposite the first end, the first end being couplable to the second portion of the one post, the second end being couplable to the battery management system (26).

15. The battery of claim 13, wherein the battery further includes a plurality of bushings, each bushing being coupled to a corresponding post.

16. The battery of claim 15, wherein each bushing is coupled to the corresponding post by forming a first weld between the bushing and the corresponding post.

17. The battery of claim 16, wherein each lead of the plurality of leads is welded to the corresponding first weld.

18. A method for assembling a lead assembly of a battery, the lead assembly comprising a plurality of leads and a lead assembly layer, the lead assembly layer having a first surface and a second surface opposite the first surface, the battery comprising a battery management system and plurality of posts associated with a plurality of battery cells, the method comprising:
arranging a plurality of leads separate from each other;
molding the lead assembly layer over the plurality of leads or securing the plurality of leads onto the first surface, the molded lead assembly layer comprising the plurality of leads between the first surface and the second surface; and
coupling each lead of the plurality of leads to one post of the plurality of posts and the battery management system.

19. The method of claim 18, wherein each lead of the plurality of leads comprises a first end and a second end opposite the first end, and the method further includes:
coupling the first end to the one post; and
coupling the second end to the battery management system.

20. The method of claim 19, wherein the method further includes:
coupling the one post to a bushing;
coupling the coupled one post and the bushing to the first end of the corresponding lead;
coupling the first connector to the second end of each lead of the plurality of leads; and
coupling the first connector to the battery management system.

21.-25. (canceled)
